(19) United States
(12) Patent Application Publication
(10) Pub. No.: US 2006/0168009 A1
(43) Pub. Date: Jul. 27, 2006

(54) Blocking unsolicited instant messages

(75) Inventors: Ruthie D. Lyle, Durham, NC (US); Michael Muller, Medford, MA (US); Andrew L. Schirmer, Andover, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/993,331

(22) Filed: Nov. 19, 2004

(51) Int. Cl. G06F 15/16; G06F 15/173

(52) U.S. Cl. 709/206; 709/225

(57) ABSTRACT

A method, system and apparatus for blocking unsolicited instant messages. A system for selectively blocking unsolicited instant messages can include an instant messaging client, at least one human sensory test and, a spim sentry. Notably, the spim sentry can be configured to selectively block an incoming instant message based upon an application of the human sensory test to a source of the incoming instant message. For example, the human sensory test can be a visual test where identifiable text is obscured in a picture. Also, the human sensory test can be an audible test where identifiable audio is obscured in an audio message.

### BACKGROUND OF THE INVENTION

1. Statement of the Technical Field

The present invention relates to unsolicited commercial electronic messages and more particularly to controlling the receipt of unsolicited instant messages.

2. Description of the Related Art

Historically, the print medium served as the principal mode of unsolicited mass advertising on the part of the direct marketing industry. Typically referred to as “junk mail”, unsolicited print marketing materials could be delivered in bulk to a vast selection of recipients, regardless of whether the recipients requested the marketing materials. With an average response rate of one to two percent, junk mail has been an effective tool in the generation of new sales leads. Nevertheless, recipients of junk mail generally find the practice to be annoying. Additionally, postage for sending junk mail can be expensive for significant “mail drops”. Consequently, the direct marketing industry constantly seeks equally effective, but less expensive modalities for delivering unsolicited marketing materials.

The advent of electronic mail has provided much needed relief for direct marketers as the delivery of electronic mail to a vast number of targeted recipients requires no postage. Moreover, the delivery of unsolicited electronic mail can be an instantaneous exercise and the unsolicited electronic mail can include embedded hyperlinks to product or service information thus facilitating an enhanced response rate for the “mail drop”. Still, as is the case in the realm of print media, unsolicited electronic mail, referred to commonly as “spam”, remains an annoyance to consumers worldwide. As a result, an entire cottage industry of “spam filters” has arisen whose task solely is the eradication of spam.

Like electronic mail, instant messaging has proven to be fertile ground for the mass marketer. Referred to in the art as “spim”, unsolicited instant messages have proven to be even a greater annoyance than spam. When received in an e-mail server, spam is not noticed by the recipient until the inbox for the e-mail server has been scanned. At worst, a “new message” notification can be activated pending the review of the newly received spam message by the recipient. In the case of instant messaging, however, the impact is immediate.

Specifically, spim when received causes the activation of a viewer which can “pop up” and distract the recipient. Moreover, spim like spam can consume network resources which can drain user productivity. Even workplace issues can arise where spim includes sexually explicit materials which can be viewed by unsuspecting passersby in proximity to the instant messenger client. Importantly, unlike e-mail based spam, instant messaging based spim cannot be merely deleted. Rather, the spim can become part of the record of the instant messaging session.

Spim often can be generated by “bots”—automated logic charged with the task of identifying possible instant messenger recipients and forwarding instant messages to the recipients as if the instant messages originated from an actual instant message user. Often, the list of instant messenger recipients can be generated randomly, or harvested through Internet probing operations. Given the level of automation available to the spim artist, estimates now place spim at epidemic levels in excess of 500 million spims per day.

Several products have attempted to address the spim epidemic. For example, anti-spim filters have been developed to identify keywords in spim in order to quash the receipt of spim messages. Additionally, it is known to block the receipt of an incoming instant message from a particular instant messenger identifier or screen name. Some systems restrict the receipt of instant messages to those which originate from within a specified domain or network. Yet other systems identify instant messenger sources which have added the recipient to a buddy list. Consequently, a “reverse buddy list” can be generated based upon which subsequent messages can be blocked which originate from users in the reverse buddy list. In all cases, however, spim remains a troublesome element of computer communications.

### SUMMARY OF THE INVENTION

The present invention addresses the deficiencies of the art in respect to spim management and provides a novel and non-obvious method, system and apparatus for blocking unsolicited instant messages. A system for selectively blocking unsolicited instant messages can include an instant messaging client, at least one human sensory test and, a spim sentry. Notably, the spim sentry can be configured to selectively block an incoming instant message based upon an application of the human sensory test to a source of the incoming instant message. For example, the human sensory test can be a visual test where identifiable text is obscured in a picture. Also, the human sensory test can be an audible test where identifiable audio is obscured in an audio message.

Preferably, a buddy list can be coupled to both the instant messaging client and to the spim sentry. Alternatively, a data source of pre-specified message sources can be coupled to both the instant messaging client and to the spim sentry. In either case, the buddy list or the data source can be consulted to determine whether the source of an instant message has been pre-authorized to send instant messages. Where the source has been pre-authorized, the human sensory test need not be applied to determine whether or not to block the instant message.

A method for selectively blocking unsolicited instant messages can include identifying a source of a received instant message. For instance, the identifying step can include identifying a screen name of a sender of the received instant message. The method further can include selecting and providing at least one human sensory test to the source. In particular, the human sensory test can be a visual test or an audible test. If the source passes the human sensory test, the instant message can be allowed. Otherwise the instant message can be blocked. Yet, the instant message can be automatically allowed without performing the selecting and providing steps if the source is located in a buddy list or in a data store of pre-specified message sources.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system configured to selectively block unsolicited instant messages; and,

FIG. 2 is a flow chart illustrating a process for selectively blocking unsolicited instant messages.

### DETAILED DESCRIPTION OF THE PREFERRED EMBODIMENTS

The present invention is a method, system and apparatus for blocking unsolicited instant messages. In accordance with the present invention, the identity of a source of an instant message can be determined upon receipt of an incoming instant message. The identity can be compared to an explicit or implicitly determined listing of approved instant message sources. If the source has not been implicitly or explicitly determined to be an approved source of instant messages, a human sensory test can be presented to the source. If the source can pass the human sensory test, the instant message can be allowed. Otherwise, the instant message can be blocked.

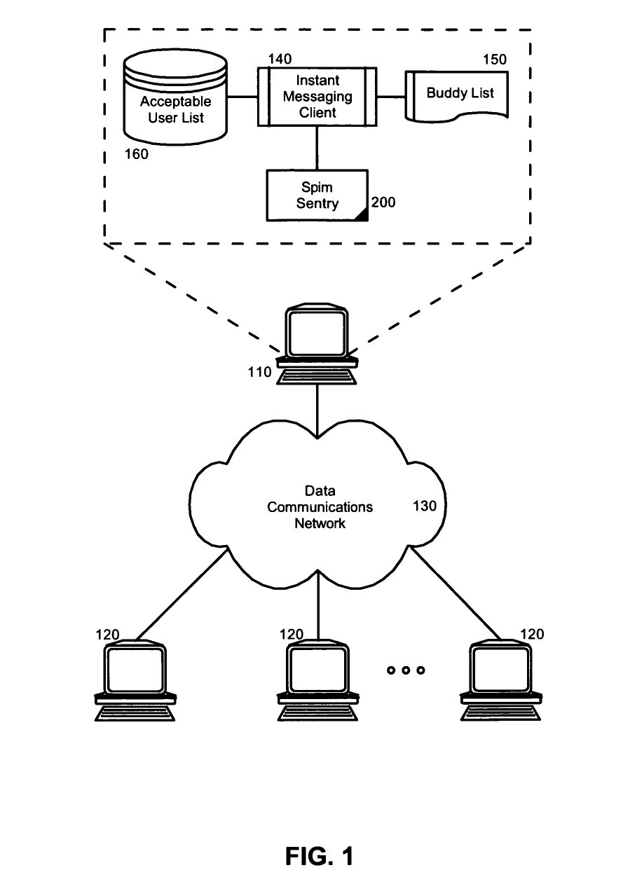

In more particular illustration, FIG. 1 is a schematic illustration of a system configured to selectively block unsolicited instant messages. The system can include a client computing platform 110 coupled to other client computing platforms 120 over a data communications network 130, for example the global Internet. The client computing platform 110 can include an instant messaging client 140 configured to exchange instant messages with one or more of the coupled client computing platforms 120 over the data communications network 130. In this regard, the instant messaging client 140 can include logic programmed both to post messages to specified recipients among the client computing platforms 120, and also to receive messages posted by individual ones of the client computing platforms 120.

The instant messaging client 140 can include a communicative linkage to a buddy list 150 and, optionally, to a data store 160 of pre-specified instant message sources. The buddy list 150 can include a listing of instant messaging partners among the client computing platforms 120 with whom it can be desirable to exchange instant messages. The data store 160 of pre-specified instant message sources, by comparison, can include a listing of instant messaging partners from whom it has been determined that transmitted instant messages are to be allowed.

Notably, a spim sentry 200 can be disposed within or associated with the instant messaging client 140 such that the spim sentry 200 can process received instant messages prior to the rendering of the instant messages by the instant messaging client 140. The spim sentry 200 can be configured to inspect a source of each received message to determine whether the received message is to be blocked or allowed. The determination not only can be based upon the content of the buddy list 150, but also the determination can be based upon the content of the data store 160 of pre-specified instant messages sources.

Importantly, where the source cannot be verified through the content of one or both of the buddy list 150 and the data store 160 of pre-specified instant message sources, a human sensory feedback test can be applied to the source. Specifically, the source can be presented with an audio or visual cue responsive to which the source can identify the cue. A favorable identification can result in the spim sentry 200 permitting the receipt of the instant message, while a failure to identify the cue can result in the blocking of the instant message.

Optionally, upon a favorable identification, the source can be added to the buddy list 150 so that source will be a priori approved to send future messages. Alternatively, upon a favorable identification, the source can be added to the data store 160 of a priori approved instant message sources. Optionally, the source can be written into the data store 160 along with a timestamp. The timestamp can be updated each time a message is allowed from the source. During the update process, the timestamp can be subtracted from the current time, resulting in a time-difference attribute indicating how recently an instant message had been received from the source. If the time-difference attribute exceeds a threshold value, the source can be required to pass a sensory test.

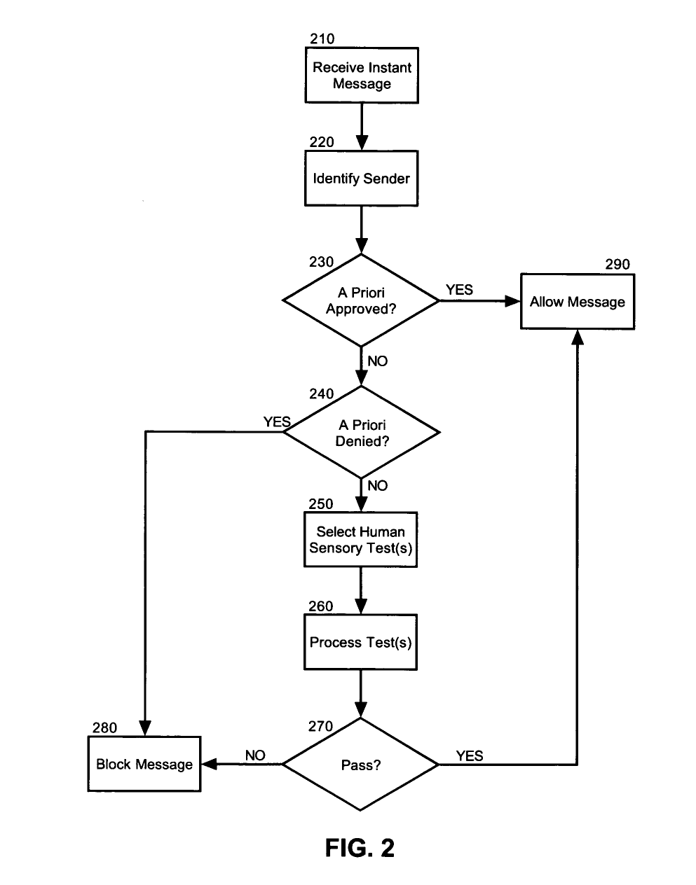

In more specific illustration, FIG. 2 is a flow chart illustrating a process for selectively blocking unsolicited instant messages as practiced by the spim sentry 200 of FIG. 1. Beginning in block 210, an instant message can be received. In block 220, a sender of the instant message can be identified, for instance by way of the handle or screen name utilized when sending the instant message. In decision block 230, it can be determined whether messages associated with the identity are considered a priori allowable. If so, in block 290 the instant message can be allowed. Otherwise, the process can continue through decision block 240.

In decision block 240, it can be determined whether messages previously had been blocked which are associated with the identity. If so, in block 280 the instant message can be blocked, otherwise, the process can continue in block 250. In block 250, one or more human sensory tests can be selected. Specifically, the recipient of the message can pre-select one or more tests to be administered to a message source from among one or more of the human sensory tests, for example a visual test or an audible test. Examples of a visual test can include the obscuring of a word, phrase or icon in a picture, while examples of an audible test can include the obscuring of an audible word or phrase in an audio message.

If the recipient of the message wishes to accommodate most people with disabilities, then the recipient may specify that only one sensory test must be passed, and that the sender of the source message may choose between two or more sensory tests. Thus, as an example a blind message source may then choose an audible test, while a deaf message source may choose a visual test. Alternatively, for stronger protection against spim, the recipient may specify that all human sensory tests must be passed by the sender of the source message regardless of the possible disability of a message source. In this case, the recipient has greater protection from undesired messages, but a sender who is blind or deaf may be able to pass only one of the two required tests, and may therefore be denied access to the recipient.

In block 260, each selected test can be processed, such as prompting the sender of the instant message to identify the word, phrase, or icon in the bit map, or to identify the word or phrase in the audio message. If, in decision block 270, it is determined that the sender has been able to pass all, or at least enough of the selected tests so as to identify the sender as a human rather than an automated bot, in block 290 the instant message can be allowed. Otherwise, in block 280 the message can be blocked.

In consequence of the present invention, it is more likely that a bot can be differentiated from a human source of an instant message. Yet, the process of vetting an incoming instant message need not impede communication with a pre-specified valid source of instant messages. To the extent that different types of human sensory tests can be applied for different modalities of interaction further can accommodate different source types including those requiring user interface accessibility. Finally, the spim sentry can be extended to incorporate any number and combination of human sensory tests to distinguish valid instant messages from spim.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A system for selectively blocking unsolicited instant messages comprising:
an instant messaging client;
at least one human sensory test; and,
a spim sentry configured to selectively block an incoming instant message based upon an application of said at least one human sensory test to a source of said incoming instant message.

2. The system of claim 1, wherein said at least one human sensory test comprises a visual test where identifiable text is obscured in a picture.

3. The system of claim 1, wherein said at least one human sensory test comprises an audible test where identifiable audio is obscured in an audio message.

4. The system of claim 1, wherein said at least one human sensory test comprises at least two user selectable human sensory tests, wherein said user is one of said source and a message recipient.

5. The system of claim 1, further comprising a buddy list coupled to both said instant messaging client and to said spim sentry.

6. The system of claim 1, further comprising a data source of pre-specified message sources coupled to both said instant messaging client and to said spim sentry.

7. A method for selectively blocking unsolicited instant messages comprising the steps of:
identifying a source of a received instant message;
selecting and providing at least one human sensory test to said source; and,
if said source passes said at least one human sensory test, allowing said instant message and otherwise blocking said instant message.

8. The method of claim 7, wherein said identifying step comprises the step of identifying a screen name of a sender of said received instant message.

9. The method of claim 7, wherein said selecting step comprises the step of selecting a human sensory test selected from the group consisting of a visual test and an audible test.

10. The method of claim 7, further comprising the step of automatically allowing said instant message without performing said selecting and providing steps if said source is located in a buddy list.

11. The method of claim 7, further comprising the step of automatically allowing said instant message without performing said selecting and providing steps if said source is located in a data store of pre-specified message sources.

12. The method of claim 7, wherein said selecting and providing steps comprises the steps of selecting and providing multiple human sensory tests and performing said allowing step only if said source passes all of said human sensory tests.

13. The method of claim 7, wherein said selecting and providing steps comprises the steps of selecting and providing multiple human sensory tests and performing said allowing step only if said source passes a threshold number of said human sensory tests.

14. The method of claim 11, further comprising the step of adding said source to said data store of pre-specified message sources if said source passes said at least one human sensory test.

15. The method of claim 11, wherein said automatically allowing step comprises the step of automatically allowing said instant message without performing said selecting and providing steps if said source is located in a data store of pre-specified message sources and if said source had recently had an instant message allowed within a threshold period of time.

16. A machine readable storage having stored thereon a computer program for selectively blocking unsolicited instant messages, the computer program comprising a routine set of instructions which when executed by a machine causes the machine to perform the steps of:
identifying a source of a received instant message;
selecting and providing at least one human sensory test to said source; and,
if said source passes said at least one human sensory test, allowing said instant message and otherwise blocking said instant message.

17. The machine readable storage of claim 16, wherein said identifying step comprises the step of identifying a screen name of a sender of said received instant message.

18. The machine readable storage of claim 16, wherein said selecting step comprises the step of selecting a human sensory test selected from the group consisting of a visual test and an audible test.

19. The machine readable storage of claim 16, further comprising an additional set of instructions which when executed by the machine causes the machine to further perform the step of automatically allowing said instant message without performing said selecting and providing steps if said source is located in a buddy list.

20. The machine readable storage of claim 16, further comprising an additional set of instructions which when executed by the machine causes the machine to further perform the step of automatically allowing said instant message without performing said selecting and providing steps if said source is located in a data store of pre-specified message sources.

21. The machine readable storage of claim 16, wherein said selecting and providing steps comprises the steps of selecting and providing multiple human sensory tests and performing said allowing step only if said source passes all of said human sensory tests.

22. The machine readable storage of claim 16, wherein said selecting and providing steps comprises the steps of selecting and providing multiple human sensory tests and performing said allowing step only if said source passes a threshold number of said human sensory tests.

23. The machine readable storage of claim 20, further comprising an additional set of instructions which when executed by the machine causes the machine to further perform the step of adding said source to said data store of pre-specified message sources if said source passes said at least one human sensory test.

24. The machine readable storage of claim 20, wherein said automatically allowing step comprises the step of automatically allowing said instant message without performing said selecting and providing steps if said source is located in a data store of pre-specified message sources and if said source had recently had an instant message allowed within a threshold period of time.
